(19) United States
(12) Patent Application Publication
(10) Pub. No.: US 2008/0317076 A1
(43) Pub. Date: Dec. 25, 2008

(54) CONTROLLING OUTPUT WAVELENGTH OF A LIGHT SOURCE

(75) Inventor: Manabu Komiyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited of Kawasaki, Japan

(21) Appl. No.: 12/141,431

(22) Filed: Jun. 18, 2008

(30) Foreign Application Priority Data
Jun. 21, 2007 (JP) 2007-163310

(51) Int. Cl. H01S 3/10; H01S 3/213

(52) U.S. Cl. 372/28; 372/32

(57) ABSTRACT

A light source module including: an LD element outputting a laser light; a lens receiving the laser light and outputting a focused light; an optical filter having transmission wavelength characteristics, inputting the focused light, and outputting a transmitted light and a reflected light based on the transmission wavelength characteristics, a light-receiving element detecting the reflected light which passes thorough the lens and generating a detection signal; and a control unit configured to control an output wavelength of the LD element based on the detection signal.

### DESCRIPTION OF THE RELATED ART

For light source modules used in broad-band optical transmission systems, such as dense wavelength division multiplexing (DWDM) optical transmission system, it is important to stabilize output wavelength. An output wavelength of an LD element, used as a light source, varies because of temperature changes or age deterioration. For this reason, light source modules used in broad-band optical transmission systems generally have a wavelength lock function. Control by the wavelength lock function means control for fixing the wavelength of light output from the light source module at a predetermined wavelength.

With a size reduction of communication equipment in optical transmission systems, a size reduction of a light source module provided in the optical transmission system is also demanded. An example of a light source module (LD module) is a transmitter optical sub assembly (TOSA) module.

For example, Japanese Unexamined Patent Application Publication No. 2001-284711 discloses a light source module having a wavelength lock function. FIGS. 9 and 10 show the configuration of a conventional light source module.

In the light source module shown in FIG. 9, a collimator lens 2 generates a collimated beam from laser light generated by an LD element 1. Backward light (back scattering light) from the LD element 1 is guided to a beam splitter 52 via a lens 51. The beam splitter 52 splits and guides the backward light to a light-receiving element 53 and a light-receiving element 54. The light-receiving element 53 detects the power of the backward light. Between the beam splitter 52 and the light-receiving element 54, an etalon filter 3 is provided. The etalon filter 3 transmits only light having a predetermined wavelength. Therefore, the light-receiving element 54 detects the power of the light having the predetermined wavelength.

The light power of the LD element 1 is controlled by a power control circuit (not shown) based on the output from the light-receiving element 53. The wavelength of laser light generated by the LD element 1 is tuned by a wavelength control circuit (not shown) so that the power of light passing through the etalon filter 3 becomes largest or equal to a desired value. The output wavelength of the LD element 1 is thereby locked at the transmission wavelength of the etalon filter 3.

The light source module shown in FIG. 10 includes beam splitters 55 and 56 for splitting a light beam. The beam splatters 55 and 56 guide parts of the light beam to light-receiving elements 53 and 54, respectively. Between the beam splitter 56 and the light-receiving element 54, an etalon filter 3 is provided. The light power and output wavelength of an LD element 1 are tuned by the same method as that adopted in the light source module shown in FIG. 9.

In the configurations shown in FIGS. 9 and 10, the wavelength lock function (or light power control) is realized by splitting laser light or backward light by the beam splitter or beam splatters and monitoring the split light. Since the configurations include the light-receiving element or light-receiving elements for detecting light traveling in the direction orthogonal to the light beam, it is difficult to reduce the size in the direction orthogonal to the light beam.

For example, Japanese Unexamined Patent Application Publication No. 2002-232050 discloses an optical module in which reflected light from an etalon filter does not return to a beam output portion of a semiconductor laser. Japanese Patent No. 2914748 and Japanese Unexamined Patent Application Publication Nos. 2000-12968 and 10-79723 disclose optical modules having a wavelength control function or a wavelength lock function.

### SUMMARY OF THE INVENTION

A light source module including: an LD element outputting a laser light; a lens receiving the laser light and outputting a focused light; an optical filter having transmission wavelength characteristics, inputting the focused light, and outputting a transmitted light and a reflected light based on the transmission wavelength characteristics, a light-receiving element detecting the reflected light which passes thorough the lens and generating a detection signal; and a control unit configured to control an output wavelength of the LD element based on the detection signal.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DRAWINGS

FIG. 1 shows the configuration of a light source module according to an embodiment;

FIG. 2A shows the reflection characteristic of an etalon filter;

FIG. 2B shows the reflection characteristic of the etalon filter;

FIGS. 3A, 3B, and 3C show the structure and characteristics of the etalon filter;

FIG. 4 shows the configuration of a control system of the light source module;

FIG. 5 shows a system for controlling the output wavelength of an LD element in the embodiment;

FIG. 6 explains dithering control;

FIGS. 7A and 7B show a light source module according to another embodiment;

FIGS. 8A and 8B show a light source module according to a further embodiment;

FIG. 9 shows a conventional configuration of a light source module; and

FIG. 10 shows a conventional configuration of another light source module.

### DESCRIPTION OF THE PREFERRED EMBODIMENTS

Reference will now be made in detail to embodiments of the present invention, examples of which are illustrated in the accompanying drawings, wherein like reference numerals refer to like elements throughout.

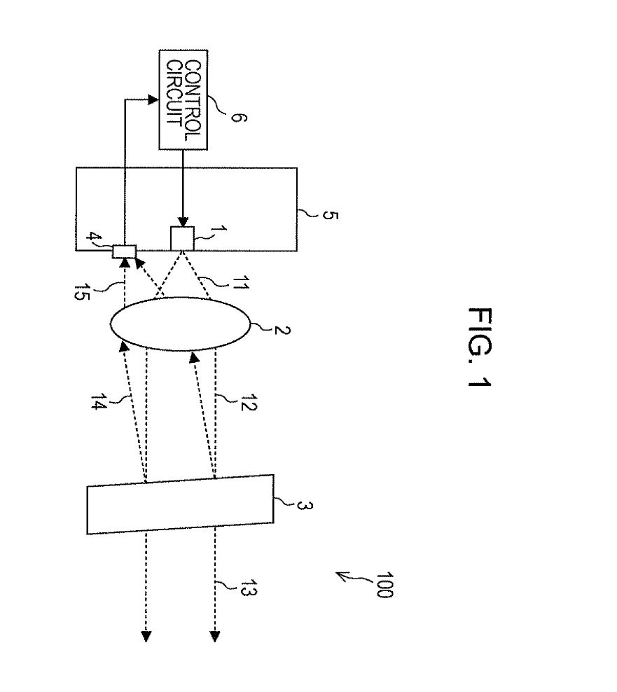

FIG. 1 shows a configuration of a light source module according to an embodiment. A light source module 100 shown in FIG. 1 includes an LD element 1, a collimator lens 2, an etalon filter 3, and a light-receiving element 4.

The LD element 1 is, for example, a semiconductor laser, and oscillates at an inherent oscillation frequency (resonant wavelength). In other words, laser light 11 generated by the LD element 1 has an inherent output wavelength. The output wavelength of the LD element 1 shifts in accordance with the temperature. Additionally, the output wavelength of the LD element 1 sometimes shifts because of age deterioration. For these reasons, the light source module 100 has a wavelength lock function for fixing the output wavelength of the LD element 1 to a predetermined value.

The output wavelength of the LD element 1 is tuned by using a wavelength control signal. There are several methods for tuning the output wavelength of the LD element 1 and one of the methods is controlling the output wavelength by changing the current to be applied to the LD element 1. In this case, the wavelength control signal is a signal that indicates a current to be applied to the LD element 1.

Another one of the methods is controlling the output wavelength by changing the temperature of the LD element 1 itself. In this case, the wavelength control signal is a signal that indicates temperature. The wavelength control signal is generated by a control circuit 6.

The laser light 11 generated by the LD element 1 enters the collimator lens 2. The collimator lens 2 converts the laser light 11 into a collimated beam 12. On the optical path of the collimated beam 12, the etalon filter 3 is provided. The etalon filter 3 is formed by, for example, a Fabry-Perot etalon, and includes a pair of semitransparent reflecting surfaces arranged parallel to each other. The Fabry-Perot etalon can be obtained by evaporating a semitransparent film serving as a reflecting mirror on each surface of a glass substrate, for example.

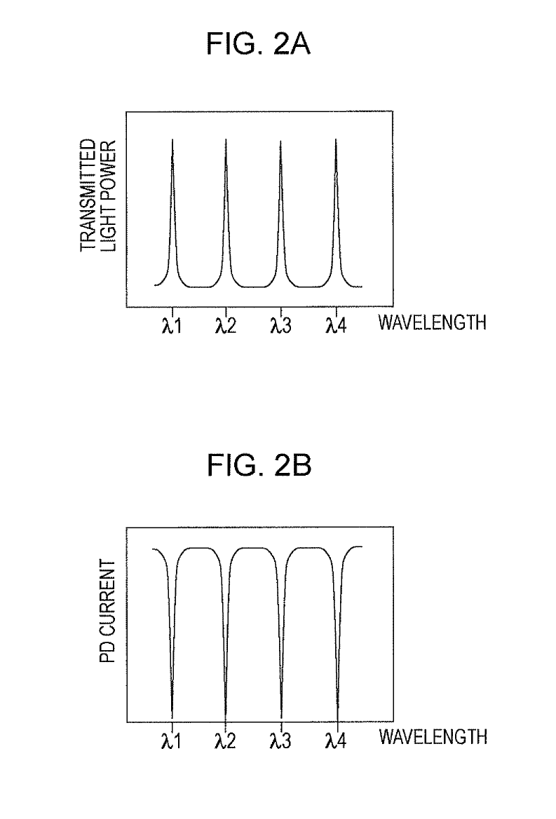

FIG. 2A shows a transmission characteristic of the etalon filter 3. In FIG. 2A, the horizontal axis indicates the wavelength of light incident on the etalon filter 3, and the vertical axis indicates the power of light transmitted by the etalon filter 3. The etalon filter 3 transmits only light with one or a plurality of predetermined wavelength bands.

In FIG. 2A, the etalon filter 3 transmits light with wavelengths λ1, λ2, λ3, and λ4. Therefore, when the output wavelength of the LD element 1 is λ1 (or λ2, λ3, λ4), the collimated beam 12 passes through the etalon filter 3. A light beam passing through the etalon filter 3 (hereinafter referred to as a light beam 13) serves as an output light beam of the light source module 100. For example, the light beam 13 is collected by a light collecting lens, and is guided to an incident surface of an optical fiber.

When the output wavelength of the LD element 1 is shifted from λ1 (or λ2, λ3, λ4), the collimated beam 12 does not pass through the etalon filter 3, but is reflected by the etalon filter 3. Reflected light 14 from the etalon filter 3 is guided to the collimator lens 2. The reflected light 14 (15) is focused on a predetermined spot by the collimator lens 2. The focus spot of the reflected light 15 is formed near the LD element 1. However, the focus spot of the reflected light 15 is formed apart from a light-emitting surface of the LD element 1 to an extent such that the laser light 11 and the reflected light 15 do not interfere with each other.

The light-receiving element 4 is, for example, a photodiode, and is provided at the focus spot of the reflected light 15. As described above, the focus spot of the reflected light 15 is formed near the LD element 1. In other words, the light-receiving element 4 is disposed near the LD element 1. In this embodiment, the LD element 1 and the light-receiving element 4 are provided in the same career. In this way, the LD element 1, the collimator lens 2, the etalon filter 3, and the light-receiving element 4 are designed and arranged so that the reflected light 14 or 15 from the etalon filter 3 is guided to the light-receiving element 4.

The control circuit 6 controls the output wavelength of the LD element 1 based on the output from the light-receiving element 4. More specifically, the output wavelength of the LD element 1 is controlled so as to be equalized to the transmission wavelength band (for example, λ₁) of the etalon filter 3. In other words, the control circuit 6 generates a wavelength control signal for holding the output wavelength of the LD element 1 at the transmission wavelength band (for example, λ1) of the etalon filter 3.

FIG. 2B shows a reflection characteristic of the etalon filter 3. In FIG. 2B, the horizontal axis indicates the wavelength of light incident on the etalon filter 3, and the vertical axis indicates the PD current output from the light-receiving element 4. The light-receiving element 4 outputs a PD current that is proportional to the power of light reflected by the etalon filter 3. Therefore, the vertical axis in FIG. 2B indicates the power of reflected light from the etalon filter 3.

As shown in FIG. 2B, when the wavelength of light incident on the etalon filter 3 is at the transmission wavelength bands (λ1, λ2, λ3, λ4), the power of reflected light from the etalon filter 3 is extremely small (or is minimized). In other words, when the output wavelength of the LD element 1 is tuned to the transmission wavelength band of the etalon filter 3, the PD current from the light-receiving element 4 becomes extremely small. This means that the output wavelength of the LD element 1 is made to equal the transmission wavelength band of the etalon filter 3, by being controlled so that the PD current becomes extremely small. Therefore, the control circuit 6 monitors the PD current output from the light-receiving element 4, and controls the output wavelength of the LD element 1 so that the PD current becomes extremely small. By this feedback control, the output wavelength of the LD element 1 is locked in the transmission wavelength band of the etalon filter 3.

In this way, the wavelength lock function of the light source module 100 is realized by guiding reflected light from the etalon filter 3, which is provided on the optical path of the collimated beam 12, to the light-receiving element 4 provided near the LD element 1 and controlling the LD element 1 based on the output from the light-receiving element 4. In other words, in the light source module 100, it is unnecessary to guide a part of a light beam generated by the LD element 1 in a direction orthogonal to the light beam in order to realize the wavelength lock function. Therefore, the size of the light source module 100 in the direction orthogonal to the light beam is reduced.

The control circuit 6 may control not only the output wavelength, but also the light power of the LD element 1 based on the output from the light-receiving element 4.

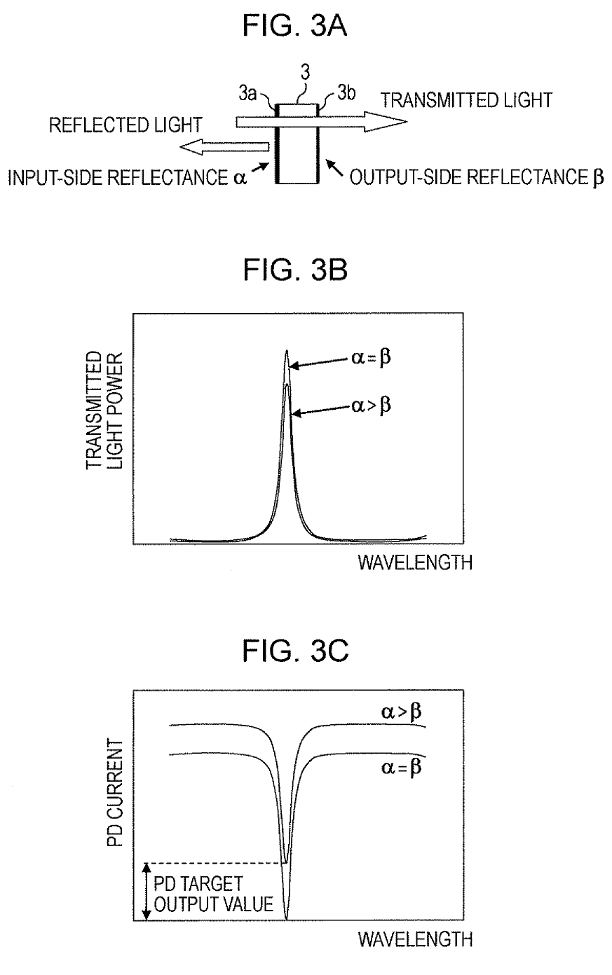

FIGS. 3A, 3B, and 3C explain the structure and characteristics of the etalon filter 3. As shown in FIG. 3A, the etalon filter 3 includes a pair of semitransparent reflecting surfaces arranged parallel to each other. In this embodiment, the etalon filter 3 includes an input-side reflecting surface 3a and an output-side reflecting surface 3b.

The transmission/reflection characteristic of the etalon filter 3 depends on the reflectance α of the input-side reflecting surface 3a and the reflectance β of the output-side reflecting surface 3b. The transmission/reflection characteristic of the etalon filter 3 will be described below with reference to FIGS. 3B and 3C. Herein, it is assumed that the center transmission wavelength band of the etalon filter 3 is λ1 and that light with a wavelength λ1 is incident on the etalon filter 3.

When the reflectances α and β are equal to each other, the transmittance of the etalon filter 3 is highest. In other words, when the reflectances α and β are equal to each other, the power of reflected light from the etalon filter 3 is minimized (ideally zero).

When the reflectances α and β are different from each other, the transmittance of the etalon filter 3 is lower than when α=β. In other words, when reflectances α and β are different from each other, the power of reflected light from the etalon filter 3 is larger than when α=β. As the difference between α and β increases, the transmittance of the etalon filter 3 decreases and the power of reflected light increases.

In the light source module 100 according to the embodiment, the etalon filter 3 is designed so that the reflectances α and β are different from each other. In this case, the reflectance a may be higher or lower than the reflectance β. The difference between α and β is designed in accordance with the power of reflected light that is estimated when the output wavelength of the LD element 1 is equal to the transmission wavelength of the etalon filter 3 (target PD output value).

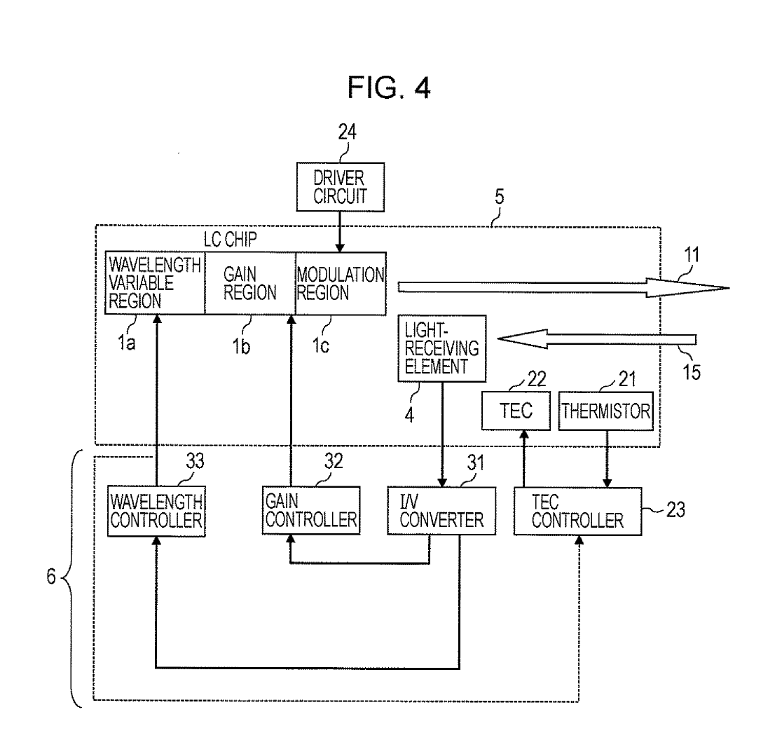

FIG. 4 shows the configuration of a control system of the light source module 100. Referring to FIG. 4, the LD element 1 includes a wavelength variable region 1a, a gain region 1b, and a modulation region 1c. The wavelength variable region 1a controls the output wavelength according to instructions from a wavelength controller 33. For example, the output wavelength is tuned by controlling the current to be applied to the LD element 1, as described above. The gain region 1b controls the light power of the LD element 1 according to instructions from a gain controller 32. The modulation region 1c modulates the laser light 11 according to a driving signal (that is, a transmission signal) from a driver circuit 24.

The LD chip 5 also includes a thermistor 21 and a thermo-electric controller (TEC) 22. The thermistor 22 detects the temperature of the LD chip 5. The TEC 22 is, for example, a Peltier module, and controls the temperature of the LD chip 5 according to instructions from a TEC controller 23. The TEC controller 23 instructs the TEC 22 to maintain a fixed temperature of the LD chip 5 according to a signal output from the thermistor 21.

The light-receiving element 4 receives reflected light 15, and generates a current value of PD that is proportional to the power of the reflected light 15. An I/V converter 31 converts the current value of PD generated by the light-receiving element 4 into a voltage value (PD current data).

The gain controller 32 controls the light power of the LD element 1 by giving a gain control command to the gain region 1b based on the PD current data. The gain control command corresponds to, for example, a difference between a predetermined reference value and the average value of the PD current data. In this case, for example, the reference value corresponds to the target light power of the LD element 1. By adopting this feedback control, the light power of the LD element 1 is maintained at the target value.

The wavelength controller 33 controls the output wavelength of the LD element 1 by giving a wavelength control command to the wavelength variable region 1a based on the PD current data. The output wavelength of the LD element 1 is controlled so as to be equalized to the transmission wavelength band of the etalon filter 3.

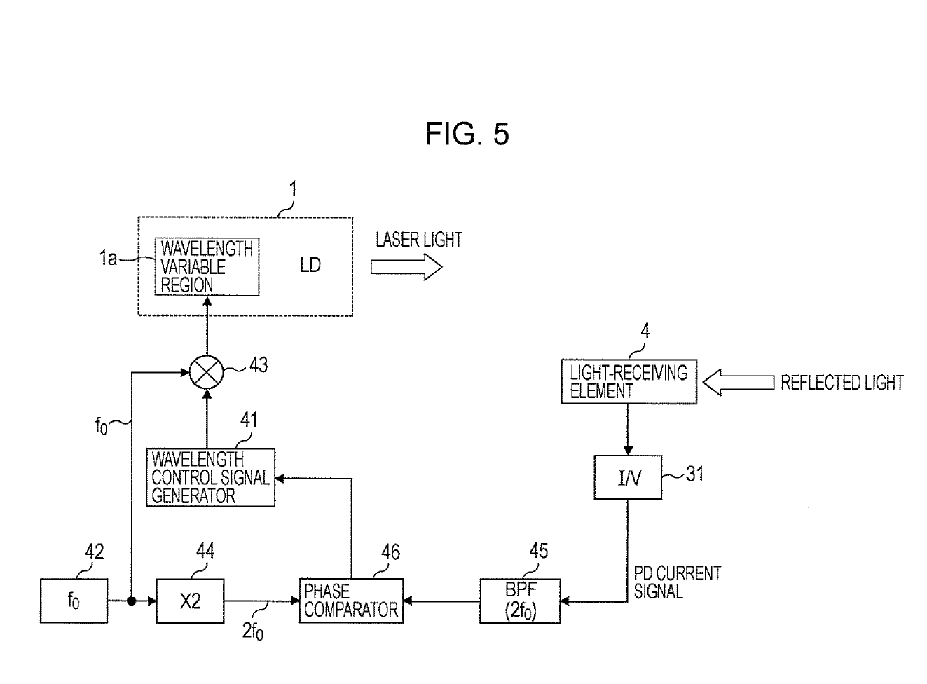

FIG. 5 shows a system for controlling the output wavelength of the LD element 1. In this embodiment, the output wavelength is controlled by dithering.

A wavelength-control-signal generator 41 generates a wavelength control signal according to a control signal from a phase comparator 46. In this embodiment, the wavelength control signal indicates a current to be applied to the LD element 1, and is, for example, a DC bias signal. A low-frequency-signal generator 42 generates a low-frequency signal having a frequency that is sufficiently lower than the frequency of a driving signal for modulating laser light. Hereinafter, the frequency of the low-frequency signal is represented by f₀. While the frequency f₀ is not specifically limited, it is, for example, several hundreds of hertz to several megahertz. A multiplier 43 superposes the low-frequency signal on the wavelength control signal. The wavelength control signal on which the low-frequency signal is superposed is transmitted to the wavelength variable region 1a of the LD element 1. In this case, the output wavelength of the LD element 1 varies in accordance with the frequency f₀, The center wavelength is determined by the wavelength control signal.

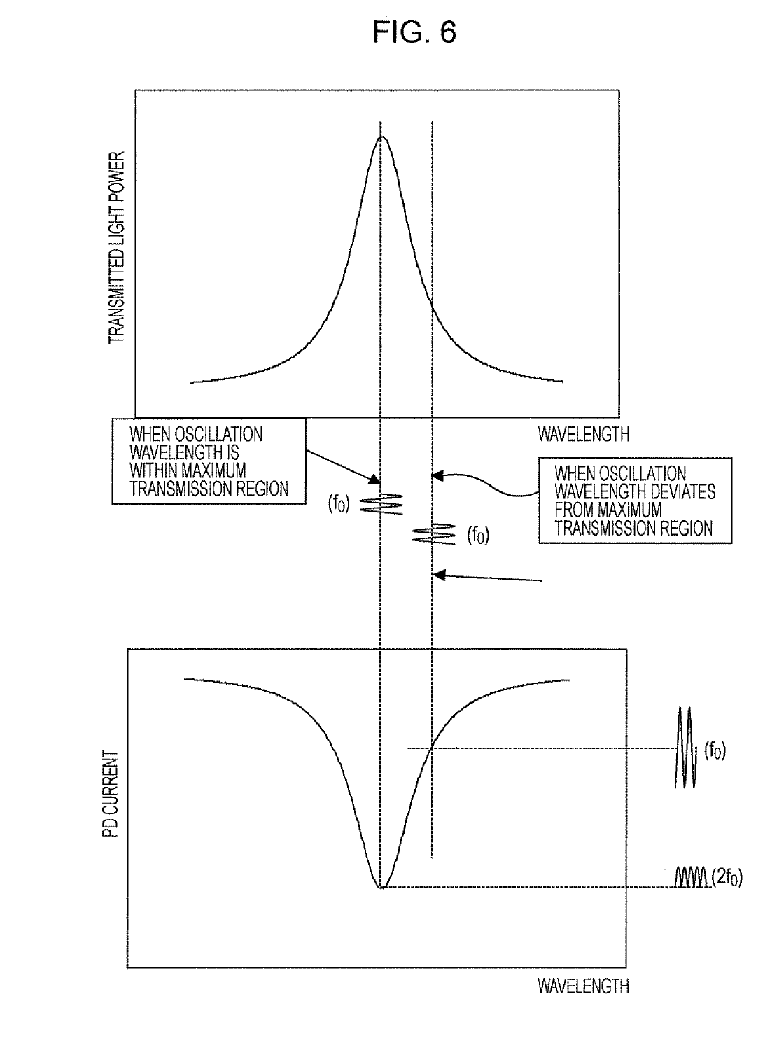

FIG. 6 explains dithering control. In FIG. 6, it is assumed that the low-frequency signal f₀ is superposed on the wavelength control signal and that the reflectances α and β of the etalon filter 3 are different from each other.

In other words, it is assumed that the PD current from the light-receiving element 4 does not become zero even when the wavelength of laser light generated by the LD element 1 is equal to the transmission wavelength band of the etalon filter 3.

(Case 1) When the output wavelength λ₀ of the LD element 1 is shifted from the transmission wavelength of the etalon filter 3:

In this case, it is assumed that the output wavelength λ₀ of the LD element 1 is longer than the transmission wavelength of the etalon filter 3. It is also assumed that the output wavelength λ₀ varies as λ₀±Δλ in accordance with the low-frequency signal.

In this case, the transmittance is low when the output wavelength is λ₀+Δλ, and is high when the output wavelength is λ₀−Δλ. In other words, the power of reflected light is large when the output wavelength is λ₀+Δλ, and is small when the output wavelength is λ₀−Δλ. Therefore, the PD current from the light-receiving element 4 oscillates at the frequency f₀. Similarly, the PD current from the light-receiving element 4 also oscillates at the frequency f₀ when the output wavelength of the LD element 1 is shorter than the transmission wavelength of the etalon filter 3.

(Case 2) When the output wavelength λ₀ of the LD element 1 is equal to the transmission wavelength of the etalon filter 3:

In this case, the transmittance is highest when the output wavelength is λ₀. When the output wavelength is λ₀+Δλ and λ₀−Δλ, the transmittance is lower than when the output wavelength is λ₀. In other words, the power of reflected power detected by the light-receiving element 4 is minimized when the output wavelength is λ₀. When the output wavelength is λ₀+Δλ and λ₀−Δλ, the power of reflected light is larger than when the output wavelength is λ₀. In other words, when the output wavelength oscillates only in one period between π₀−Δλ and λ₀−Δλ, the PD current from the light-receiving element 4 oscillates in two periods. Therefore, the PD current from the light-receiving element 3 oscillates at a frequency 2f₀.

As described above, in the light source module 100, a 2f₀ component is detected from the PD current signal when the output wavelength of the LD element 1 (center wavelength λ₀ in the above embodiment) is equal to the transmission wavelength of the etalon filter 3. In contrast, when the output wavelength of the LD element 1 is shifted from the transmission wavelength of the etalon filter 3, an f₀ component is detected from the PD current signal, but a 2f₀ component is not detected.

Therefore, the output wavelength of the LD element 1 is fixed at the transmission wavelength of the etalon filter 3 by being controlled so that a 2f₀ component is detected from the PD current signal. In other words, the wavelength lock function is realized by this control.

The light source module 100 has a function of detecting a 2f₀ component from the PD current signal in order to achieve the above-described wavelength lock function. In other words, a frequency doubling unit 44 generates a secondary low-frequency signal by doubling the frequency of the low-frequency signal. The frequency of the secondary low-frequency signal is 2f₀. A bandpass filter 45 transmits a 2f₀ component. The phase comparator 46 detects a 2f₀ component from the PD current signal by utilizing the secondary low-frequency signal.

When the phase comparator 46 does not detect a 2f₀ component from the PD current signal, it transmits, to the wavelength-control-signal generator 41, a control signal for shifting the output wavelength of the LD element 1. By this feedback control, the output wavelength of the LD element 1 approaches the transmission wavelength of the etalon filter 3. When the phase comparator 46 detects a 2f₀ component from the PD current signal, it transmits, to the wavelength-control-signal generator 41, a control signal for maintaining the wavelength control signal. The output wavelength of the LD element 1 is thereby fixed at the transmission wavelength of the etalon filter 3.

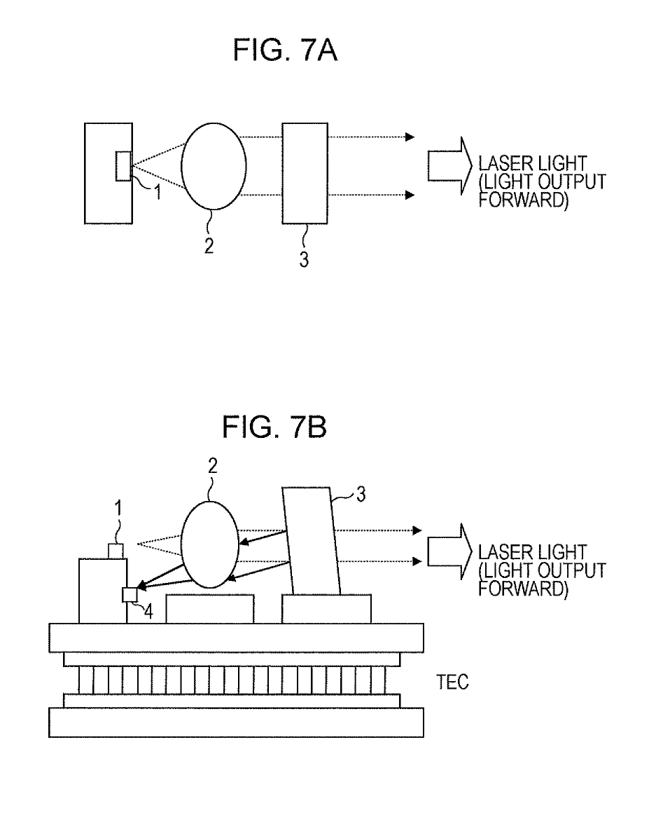

FIGS. 7A and 71 show a light source module according to another embodiment. In the light source module shown in FIGS. 7A and 7B, an LD element 1, a collimator lens 2, an etalon filter 3, and a light-receiving element 4 are mounted on a TEC module. The light-receiving element 4 is disposed below the LD element 1. Both a light-emitting surface of the LD element 1 and a light-receiving surface of the light-receiving element 4 face the collimator lens 2.

The LD element 1 and the light-receiving element 4 are fixed on the same chip. The etalon filter 3 is inclined downward by a predetermined angle so that reflected light of laser light from the LD element 1 is guided to the light-receiving element 4. The light source module having the above-described configuration operates in the same manner as the manner described above with reference to FIGS. 1 to 6.

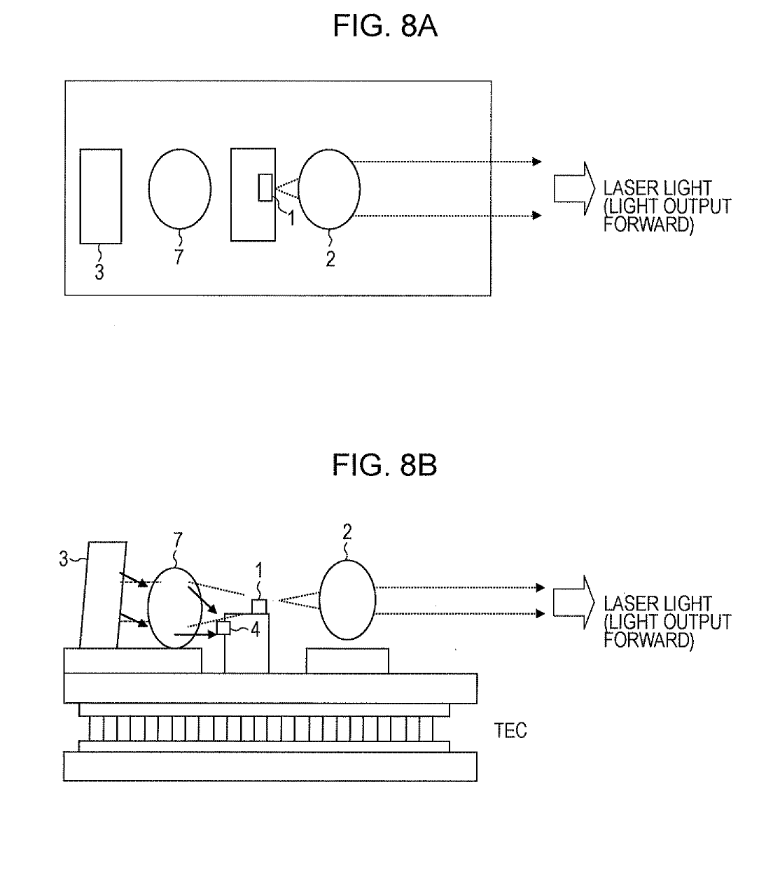

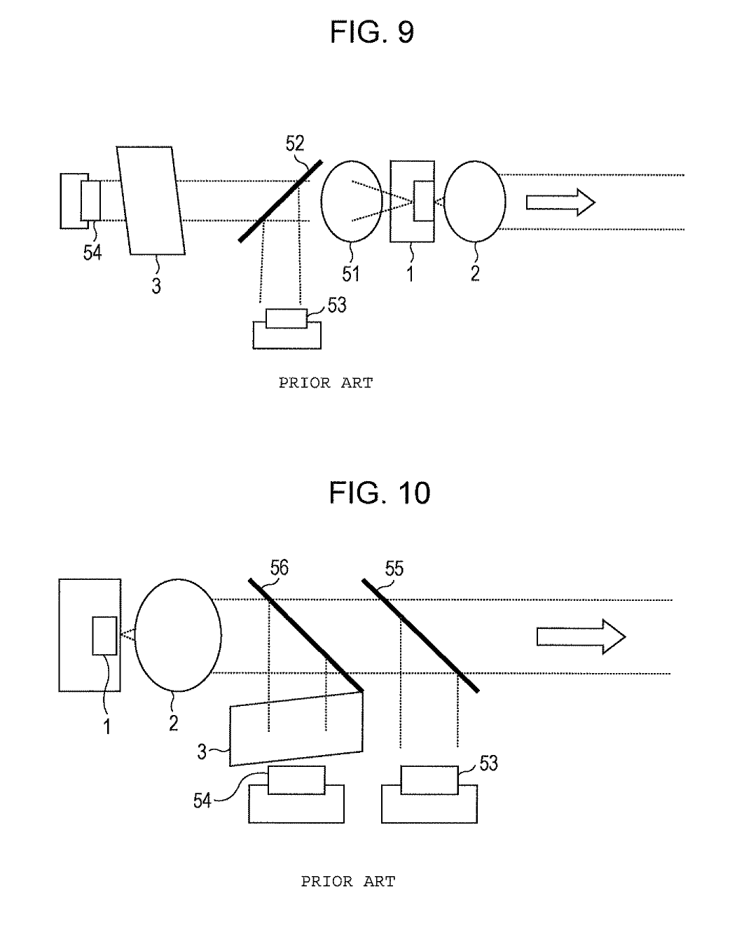

FIGS. 8A and 8B show a light source module according to a further embodiment. In the light source module shown in FIGS. 8A and 8B, an LD element 1, a collimator lens 2, an etalon filter 3, a light-receiving element 4, and a collimator lens 7 are mounted on a TEC module. A light-emitting surface of the LD element 1 faces the collimator lens 2, and a light-receiving surface of the light-receiving element 4 faces the collimator lens 7. The LD element 1 and the light-receiving element 4 are fixed on the same chip. The etalon filter 3 is disposed on the back side of the LD element 1.

In light source module shown in FIGS. 8A and 8B, laser light (forward light) generated by the LD element 1 is converted into a collimated beam and is output by the collimator lens 2. In contrast, backward light (back scattering light) from the LD element 1 is guided to the etalon filter 3 via the collimator lens 7. That is, the etalon filter 3 is disposed on the optical path of the backward light. Reflected light from the etalon filter 3 is guided to the light-receiving element 4 by the collimator lens 7. This light source module operates in the same manner as the manner described above with reference to FIGS. 1 to 6.

While the output wavelength is controlled by utilizing the current to be applied to the LD element 1 in the above-described light source modules, it may be controlled by changing other parameters, for example, the temperature of the LD element 1. In this case, the temperature of the LD element 1 can be controlled by a TEC. This structure can be realized by giving a wavelength control command, which is generated by the wavelength controller 33, to the TEC controller 23 in FIG. 4. When the optical characteristic of the etalon filter 3 depends on the temperature, a TEC for controlling the temperature of the LD chip (LD element and light-receiving element) and a TEC for controlling the temperature of the etalon filter 3 may be provided independently.

While the etalon filter is used as the optical filter having a predetermined transmission wavelength in the above-described embodiments, for example, the etalon filter may be replaced with an optical bandpass filter. The transmission wavelength of the optical filter (etalon filter in the above-described embodiments) needs to be equal to the wavelength that should be locked by the light source module.

For this reason, it is preferable that the transmission wavelength of the optical filter used in the light source module be tunable. Transmission-wavelength tunable optical filters in which the transmission wavelength is controlled, for example, by adjusting the temperature with a heater or the like or by adjusting the electric field are known.

Although several embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A light source module comprising:
an LD element outputting a laser light;
a lens receiving the laser light and outputting a focused light;
an optical filter having transmission wavelength characteristics, inputting the focused light, and outputting a transmitted light and a reflected light based on the transmission wavelength characteristics,
a light-receiving element detecting the reflected light which passes thorough the lens and generating a detection signal; and
a control unit configured to control an output wavelength of the LD element based on the detection signal.

2. The light source module according to claim 1, wherein the lens is a collimator lens configured to generate a collimated beam from the laser light.

3. The light source module according to claim 1, wherein the optical filter is an etalon filter.

4. The light source module according to claim 3, wherein an input-side reflectance and an output-side reflectance of the etalon filter are different from each other.

5. The light source module according to claim 1, further comprising:
a tuning unit tuning the transmission wavelength characteristics of the optical filter.

6. The light source module according to claim 1, wherein the control unit controls the output wavelength of the LD element by changing a current supplied to the LD element.

7. The light source module according to claim 1, wherein the LD element and the light-receiving element are provided on the same career.

8. The light source module according to claim 1, further comprising a modulation unit, wherein
the control unit controls the output wavelength of the LD element by a control signal,
the modulation unit modulates the control signal with a signal component, and
the control unit controls based on the signal component in the detection signal from the light-receiving element.

9. The light source module according to claim 8, wherein the control circuit adjusts light power of the LD element based on the average output signal from the light-receiving element.

10. The light source module according to claim 1, further comprising a modulation unit, wherein
the control unit controls the output wavelength of the LD element by a control signal,
the modulation unit superposes a low-frequency signal on the control signal, and
the control circuit controls based on a harmonic signal component of the low-frequency signal in the detection signal from the light-receiving element.

11. A method comprising:
generating a laser light;
collimating the laser light into a collimated light by a lens;
transmitting and reflecting the collimated light by a optical filter with a transmission wavelength characteristics;
detecting a reflected light from the optical filter thorough the lens;
controlling a wavelength of the laser light.

12. The method according to the claim 11, further comprising an operation of tuning the transmission wavelength characteristics of the optical filter.

13. A light source module, comprising:
an LD element outputting a laser light;
a lens focusing the laser light;
an optical filter receiving the laser light focused by the lens, transmitting a portion of the laser light and reflecting a portion of the laser light;
a light-receiving element detecting the reflected light portion which passes through the lens, and generating a detection signal; and
a control unit controlling an output wavelength of the LD element based on the detection signal.

14. The light source module according to claim 13, wherein,
the LD element and the light receiving module are provided in adjacent position.
